(19) United States
(12) Patent Application Publication
(10) Pub. No.: US 2012/0064228 A1
(43) Pub. Date: Mar. 15, 2012

(54) FORMING METHOD OF LIGHT EXTRACTING STRUCTURE, LIGHT-EMITTING SUBSTRATE HAVING LIGHT EXTRACTING STRUCTURE, AND MANUFACTURING METHOD OF IMAGE DISPLAY APPARATUS

(75) Inventors: Shin Kitamura, Machida-shi (JP); Kazuhiko Araki, Kawasaki-shi (JP); Shuji Yamada, Atsugi-shi (JP); Osamu Takamatsu, Honjo-shi (JP)

(73) Assignee: CANON KABUSHIKI KAISHA, Tokyo (JP)

(21) Appl. No.: 13/216,764

(22) Filed: Aug. 24, 2011

(30) Foreign Application Priority Data
Sep. 14, 2010 (JP) 2010-205720

(51) Int. Cl. B05D 5/06

(52) U.S. Cl. 427/66

(57) ABSTRACT

A light extracting structure which can efficiently extract light emitted from a light-emitting layer. A capture layer is formed onto a first translucent material film formed on a substrate. A dispersion liquid obtained by dispersing particles into a dispersion medium is coated onto the capture layer. The dispersion medium is volatilized. A particle sediment layer is formed onto the capture layer. The particles in the lowest layer of the sediment layer are captured into the capture layer at a filling rate of 93% or more for the 2-dimensional closest packing. The non-captured particles are removed. An etching is performed by using the captured particles as a mask. Concave portions are formed in the first translucent material film. The particles remaining after the etching and the capture layer are removed. Thereafter, the concave portions are embedded with a second translucent material having a different refractive index.

### BACKGROUND OF THE INVENTION

1. Field of the Invention

The present invention relates to a forming method of a light extracting structure which is used to allow light generated from a light-emitting layer to be easily extracted to an outside of a display surface side in order to improve a luminance of an image display apparatus for displaying an image by a light emission. The invention also relates to a manufacturing method of a light-emitting substrate having the light extracting structure and the image display apparatus.

2. Description of the Related Art

A light extracting structure is a structure in which materials having different refractive indices are periodically arranged and is ordinarily constructed by forming a fine concave/convex pattern by a photolithography step which is used in a general semiconductor microfabrication. However, when a pitch of the fine concave/convex pattern is equal to about 2 μm or less, an expensive exposing apparatus and complicated processes are necessary, so that manufacturing costs are very high.

Therefore, hitherto, as a method whereby the fine concave/convex pattern which is used as a light extracting structure can be easily formed, Japanese Patent No. 4068578 discloses the following method. That is, a particle dispersion liquid in which particles have been dispersed into a liquid dispersion medium is prepared, a capture layer containing a polymer is formed onto a substrate, and a coating film of the particle dispersion liquid is formed on the capture layer. The liquid dispersion medium is volatilized from the coating film and a sediment layer of the particles is formed on the capture layer. After that, only by heating the capture layer to a temperature which is equal to or higher than a glass transition point, only the particles in the lowest layer of the sediment layer are embedded into the capture layer by a capillary tube phenomenon. The sediment layer of the particles is dipped into the liquid and the particles which are not embedded in the capture layer are removed. A single-particle layer in which the particles in the lowest layer are arranged in the capture layer is formed, thereby forming the fine concave/convex pattern.

However, Japanese Patent No. 4068578 discloses nothing about a relation between a light extracting efficiency and a filling rate of the particles. According to the light extracting structure constructed by the fine concave/convex pattern which has merely been formed by using the method disclosed in Japanese Patent No. 4068578, there is such a problem that it is difficult to form the light extracting structure having the high light extracting efficiency.

The invention is made by finding out such a fact that the filling rate of the particles exerts a large influence on the light extracting efficiency. It is an object of the invention to enable a light extracting structure of a high light extracting efficiency to be easily obtained. It is another object of the invention to enable an image display apparatus having a high luminance to be easily manufactured.

### SUMMARY OF THE INVENTION

According to an aspect of the invention, there is provided a forming method of a light extracting structure, comprising the steps of; (a) forming a capture layer onto at least either a substrate or a film made of a first translucent material, (b) applying a dispersion liquid in which particles have been dispersed into a dispersion medium onto the capture layer, volatilizing the dispersion medium, and forming a sediment layer of the particles onto the capture layer, (c) embedding the particles in a lowest layer of the sediment layer into the capture layer and capturing, (d) removing the particles which are not captured in the capture layer, (e) using the particles captured in the capture layer as a mask, removing a part of the capture layer and the substrate or the film of the first translucent material, and forming a plurality of concave portions into the substrate or the film of the first translucent material, (f) removing the particles and the capture layer after the step (e), (g) embedding the plurality of concave portions formed in the substrate or the film of the first translucent material by a second translucent material whose refractive index differs from that of the first translucent material, wherein a particle filling rate of the particles captured in the capture layer in the step (c) is equal to 93% or more for a 2-dimensional closest packing.

According to another aspect of the invention, there are provided a manufacturing method of a light-emitting substrate having a light extracting structure for extracting light generated from a light-emitting layer and a manufacturing method of an image display apparatus, wherein the light extracting structure is formed by the forming method of the light extracting structure according to the invention.

In the invention, the fine concave/convex pattern necessary as a light extracting structure is formed by arranging the particles and using them as a mask. Therefore, such a light extracting structure can be easily obtained without using the expensive exposing apparatus and complicated processes. Since the particles arranged at a high particle filling rate are used as a mask, the light extracting structure having a high light extracting efficiency can be obtained. The forming method of the light extracting structure according to the invention can be used to manufacture the light-emitting substrate having the light extracting structure and the image display apparatus. The image display apparatus of a high luminance can be easily manufactured.

Further features of the present invention will become apparent from the following description of exemplary embodiments with reference to the attached drawings.

### BRIEF DESCRIPTION OF THE DRAWINGS

FIG. 1 is a perspective view illustrating an example of an image display apparatus which is manufactured by a manufacturing method of the invention.

FIGS. 2A and 2B are diagrams schematically illustrating a construction of a face plate illustrated in FIG. 1, in which FIG. 2A is a partially enlarged cross sectional view and FIG. 2B is an enlarged cross sectional view taken along the line 2B-2B in FIG. 2A.

FIGS. 3A, 3B, 3C, 3D, 3E, 3E′, 3F, 3G, 3H, 31, 3J and 3K are schematic explanatory diagrams of a forming method of a light extracting structure.

FIGS. 4A and 4B are schematic explanatory diagrams of a manufacturing method of the face plate.

FIG. 5 is a schematic explanatory diagram of an evaluating apparatus of a light extracting efficiency.

### DESCRIPTION OF THE EMBODIMENTS

The present invention relates to a forming method of a light extracting structure for extracting light generated from a light-emitting layer, a manufacturing method of a light-emitting substrate having the light extracting structure and an image display apparatus.

According to the forming method of the light extracting structure of the invention, the light extracting structure is formed by the following steps (a) to (g). In the step (c), a particle filling rate of particles captured in a capture layer is equal to 93% or more for a 2-dimensional closest packing.

(a) The capture layer is formed onto a substrate made of a first translucent material or a film made of the first translucent material formed on the substrate.

(b) A dispersion liquid in which particles have been dispersed into a dispersion medium is applied onto the capture layer, the dispersion medium is volatilized, and a sediment layer of the particles is formed onto the capture layer.

(c) The particles in the lowest layer of the sediment layer are embedded into the capture layer and captured.

(d) The particles which are not captured in the capture layer are removed.

(e) The particles captured in the capture layer are used as a mask, a part of the capture layer and the substrate or the film made of the first translucent material are removed, and a plurality of concave portions are formed in the substrate or the film of the first translucent material.

(f) After the step (e), the particles and the capture layer are removed.

(g) The plurality of concave portions formed in the substrate or the film of the first translucent material are embedded with a second translucent material whose refractive index differs from that of the first translucent material.

The exemplary embodiments of a manufacturing method of the invention will be described hereinbelow with reference to the drawings. However, the invention is not limited to the embodiments, which will be described hereinbelow.

As image display apparatuses which are manufactured by using the invention, besides a field emission display (FED), an electroluminescence display (EL), a cathode ray tube display (CRT), a light emitting diode display (LED), a plasma display (PDP), and the like can be mentioned. Among them, the invention can be desirably applied to the FED and EL in which it is desirable to provide a light extracting structure in order to improve a luminance. The embodiments of the invention will be specifically described hereinbelow with respect to the FED as an example.

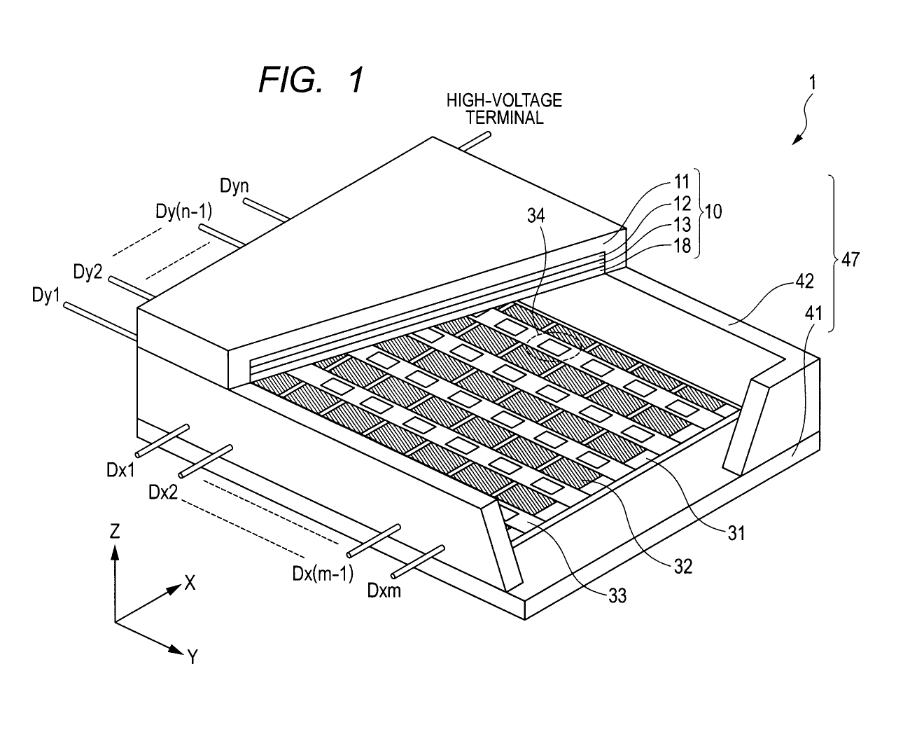

FIG. 1 is a perspective view illustrating an example of an image display apparatus (FED) which is manufactured by the manufacturing method of the invention. An image display apparatus 1 in FIG. 1 is illustrated with a part cut away in order to illustrate its internal structure. In the image display apparatus 1 in FIG. 1, a substrate 31 on an electron source side, scanning wirings 32, modulation wirings 33, and electron-emitting devices 34 are provided. The electron source substrate 31 is fixed by a rear plate 41. In the image display apparatus 1 in FIG. 1, a face plate 10 serving as an light-emitting substrate is provided. In the face plate 10, a light extracting structure 12, an anode electrode 13, and a phosphor film 18 serving as a light-emitting layer are laminated and formed in this order onto an inner surface of a substrate (transparent substrate) 11 on the light-emitting layer side. In the SED, CRT, and PDP, a light-emitting substrate has a substrate construction including the phosphor film 18 serving as a light-emitting layer. In the EL and LED, a layer which emits light by using an electroluminescence effect is the light-emitting layer and the substrate construction including the light-emitting layer corresponds to the light-emitting substrate. In the image display apparatus 1 in FIG. 1, a supporting frame 42 is provided. The rear plate 41 and the face plate 10 are attached to the supporting frame 42 through frit glass or the like, respectively, thereby forming an envelope 47. Since the rear plate 41 is provided mainly to reinforce a strength of the substrate 31, if the substrate 31 itself has an enough large strength, the rear plate 41 which is separately provided is unnecessary. By arranging a supporting member called a spacer (not illustrated) between the face plate 10 and the rear plate 41, a structure having an enough strength against the atmospheric pressure can be also realized.

The m scanning wirings 32 are connected to terminals Dx1, Dx2, . . . , and Dxm, respectively. The n modulation wirings 33 are connected to terminals Dy1, Dy2, and Dyn, respectively (m and n are positive integers). Interlayer insulating layers (not illustrated) are arranged between the m scanning wirings 32 and the n modulation wirings 33, thereby electrically insulating them.

A high-voltage terminal is connected to the anode electrode 13. A DC voltage of, for example, a few kV is supplied to this terminal. Such a DC voltage is an accelerating voltage for applying such an enough energy that an electron which is emitted from the electron-emitting device 34 excites phosphor. The electrons which were emitted from the electron-emitting device 34 and accelerated are irradiated to the phosphor film 18 so as to emit the light, thereby displaying an image.

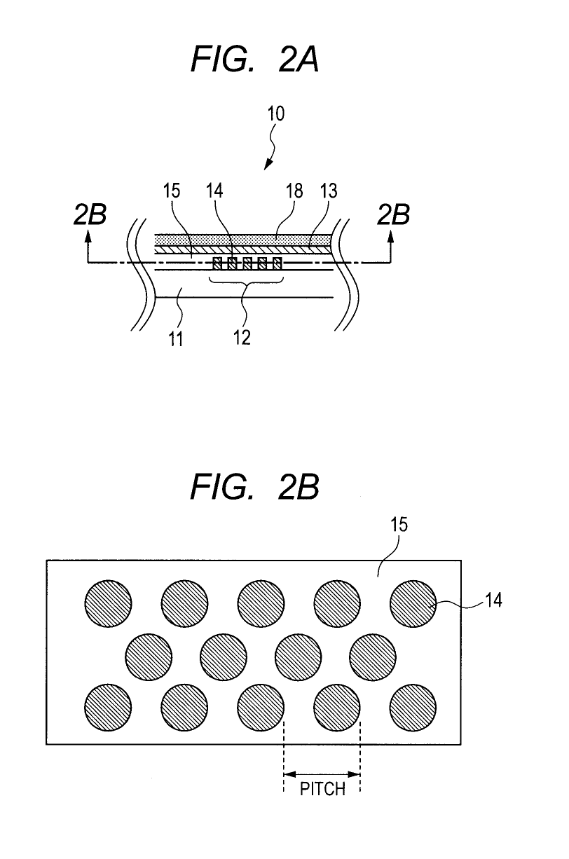

A construction of the face plate 10 serving as a component element of the image display apparatus in FIG. 1 will be further described with reference to FIGS. 2A and 2B.

The light extracting structure 12 to extract the light generated by the light emission of the phosphor film 18 to the substrate 11 side is formed on the substrate 11 constructing the face plate 10. As a substrate 11, for example, a substrate of floating glass such as soda lime glass, no-alkali glass, or the like can be used. The anode electrode 13 formed by a transparent electrode such as ITO or the like is formed on the substrate 11. The phosphor film 18 containing a number of phosphor particles is formed on the anode electrode 13. The phosphor film 18 may be partitioned so as to have a predetermined area by providing a black matrix onto the anode electrode 13.

The light extracting structure 12 is formed in a specific region on the substrate 11. The light extracting structure 12 has such a structure that a film 14 made of a first translucent material and a film 15 made of a second translucent material whose refractive index differs from that of the film 14 are alternately periodically arranged as illustrated in FIGS. 2A and 2B.

Subsequently, a forming method of the light extracting structure 12, a manufacturing method of the face plate 10 serving as an light-emitting substrate, and further, a manufacturing method of the image display apparatus will be described.

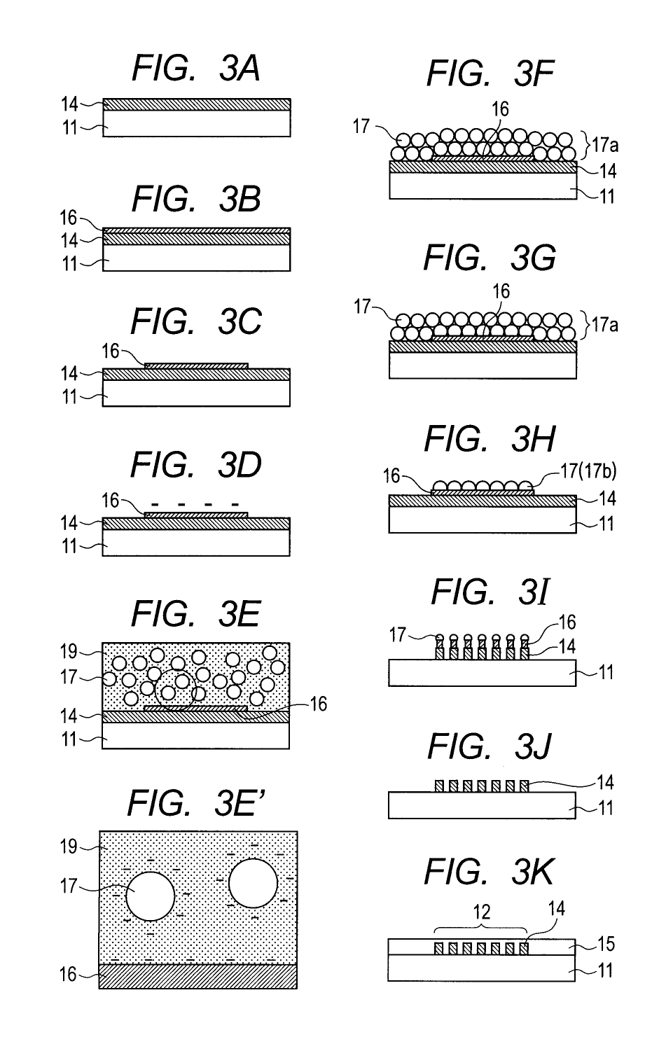

(1) Creation of First Translucent Material Film (FIG. 3A)

First, as illustrated in FIG. 3A, the film 14 of the first translucent material is formed onto the substrate 11. As a first translucent material, an inorganic material having a light transmittance and a predetermined refractive index can be mentioned. Specifically speaking, TiO₂ (refractive index: 2.2), ZrO₂, or the like can be mentioned. As a method of forming the film 14 of the first translucent material, a general thin film forming method such as sputtering method, vacuum evaporation deposition method, or the like can be used. A procedure for forming the film 14 of the first translucent material is illustrated in FIGS. 3A to 3K. However, if the substrate 11 itself is made of the first translucent material, the creation of the film 14 of the first translucent material can be omitted.

(2) Creation of Capture Layer (FIG. 3B)

Subsequently, a capture layer 16 is formed as a film onto the film 14 of the first translucent material as illustrated in FIG. 3B. If the substrate 11 itself is made of the first translucent material, the capture layer 16 is formed onto the substrate 11. The capture layer 16 is not particularly limited but any one of a low molecular material and a high molecular material can be used so long as particles can be captured as will be described hereinafter. The capture layer 16 is, desirably, a layer containing a polymer. A case where the capture layer 16 is a layer containing the polymer will be described hereinbelow.

The polymer contained in the capture layer 16 may be amorphous or crystalline. The polymer contained in the capture layer 16 is a material whose glass transition point or melting point is, desirably, lower than a glass transition point or melting point of a material constructing particles, which will be described hereinafter. For example, a thermoplastic resin which has a glass transition point and exhibits a flowability at least once by heating can be mentioned. However, if the polymer contained in the capture layer 16 is the thermoplastic resin, it is desirable that its glass transition temperature is equal to or higher than a room temperature. Even in the thermoplastic resin, it is particularly desirable to use a thermoplastic photoresist in terms of a point that the photolithography method can be used upon patterning of the capture layer 16, which will be performed in the subsequent step.

When the light extracting structure is formed by the method of the invention, it is desirable that after the capture layer 16 was formed, surface charges of the capture layer 16 are controlled for a dispersion medium 19, which will be described hereinafter. For this purpose, as a component material of the capture layer 16, it is desirable to select a high molecular material whose surface charges can be easily controlled. Specifically speaking, it is desirable to select a high molecular material having a polar functional group such as —OH, —COOH, or the like.

It is desirable to set a film thickness of capture layer 16 to a value which is equal to or less than a middle diameter (center value of particle size distribution) of the particles deposited onto the capture layer 16 in the subsequent step.

The forming method of the capture layer 16 is not particularly limited. Generally, the capture layer 16 can be formed by coating a solution of the component material of the capture layer 16 onto the film 14 of the first translucent material or the substrate 11 of the first translucent material. A coating method of the solution is not particularly limited either. For example, a well-known coating method such as spin coating method, dipping method, slit coating method, or the like can be used. Among them, the slit coating method is desirable because a thin film having a large area and a predetermined pattern can be formed.

(3) Patterning of Capture Layer (FIG. 3C)

Subsequently, the capture layer 16 formed by the just previous step is patterned so as to correspond to a pixel pattern of the image display apparatus as illustrated in FIG. 3C. A patterning method is not particularly limited. For example, a general photolithography method can be used.

(4) Ground Process (FIG. 3D)

Subsequently, as illustrated in FIG. 3D, a surface treatment (ground process) of the capture layer 16 is executed just before a particle dispersion liquid is applied onto the capture layer 16.

In the method of the invention, desirably, the surface potential of the capture layer 16 is controlled for the dispersion medium 19 of the dispersion liquid, which will be described hereinafter, (refer to FIGS. 3E and 3E′). Much desirably, the surface potential of the capture layer 16 is raised for the dispersion medium 19. If the dispersion medium 19 is water, as a specific method of raising the surface potential of the capture layer 16, desirably, the surface treatment is executed so that a water contact angle of the surface of the capture layer 16 is equal to 30° or less. Much desirably, the surface treatment is executed so that a water contact angle of the surface of the capture layer 16 is equal to 10° or less. As a specific method of the surface treatment of the capture layer 16, a method of using an ultraviolet rays irradiation or the plasma process can be mentioned. When the component material of the capture layer 16 is a high molecular material having the polar functional group such as —OH group, —COOH group, or the like, the contact angle can be increased by further enhancing a surface polarity by the ultraviolet rays irradiation or the plasma process.

In the method of the invention, desirably, the surface potential of the particles contained in the particle dispersion liquid is controlled for the dispersion medium 19 of the dispersion liquid (refer to FIGS. 3E and 3E′). Much desirably, the surface potential of the particles 17 contained in the particle dispersion liquid (refer to FIGS. 3E and 3E′) is raised for the dispersion medium 19. Reasons why it is desirable to control the surface potential of the particles 17 as mentioned above will be described hereinafter.

(5) Applying (Coating) of Dispersion Liquid (FIG. 3E)

Subsequently, the dispersion liquid in which the particles 17 were dispersed into the dispersion medium 19 is prepared and the dispersion liquid is applied onto the capture layer 16. The particles 17 and dispersion medium 19 contained in the dispersion liquid will be described hereinbelow.

Particles

When the film 14 of the first translucent material is etched, the particles 17 dispersed in the dispersion liquid function as what is called an etching mask. A component material of the particles 17 is not particularly limited. Specifically speaking, an organic material, an inorganic material, or an organic-inorganic composite material can be used. Among those materials, silica particles are desirable. In the particles 17, it is desirable that a glass transition point or melting point of the material constructing the particles 17 is higher than the glass transition point or melting point of the material constructing the capture layer 16. As a shape of each particle 17, a state where it has a spherical shape and a high circularity and its particle size distribution is narrow is desirable from a viewpoint of raising a regularity of the concave portions which are formed in the film 14 of the first translucent material which is etching-molded and will be described hereinafter or in the substrate 11 of the first translucent material. The particle size distribution is defined by the following equation (1).

[Particle size distribution (%)]=([particle size standard deviation]/[average particle size])×100 (1)

In the equation (1), the average particle size indicates a mean value of measured diameters of 100 particles 17 extracted at random. The particle size standard deviation indicates a standard deviation obtained with respect to the 100 particles. The particle size distribution which is obtained by the equation (1) is desirably equal to 5% or less, much desirably, 2% or less.

Specifically speaking, the average particle size of the particles 17 contained in the particle dispersion liquid is obtained by selecting 100 particles among the particles 17 photographed by an electron microscope and analyzing images of the 100 particles 17.

The particle size corresponds to a pitch of the fine concave/convex pattern in the light extracting structure 12. Now, the particle size of each of the particles 17 which are used when manufacturing the image display apparatus is, desirably, equal to 3000 nm or less, much desirably, 200 to 2000 nm.

In the invention, in order to regularly capture and arrange the particles 17 onto the capture layer 16, it is desirable to control the surface potential of the particles 17 for the dispersion medium 19. As one of desirable factors to be considered when controlling the surface potential of the particles 17, there is a ζ (zeta) potential of the particles 17 dispersed in the dispersion medium 19. When considering the ζ (zeta) potential of the particles 17, as a condition adapted to regularly arrange the particles 17, it is desirable that the surface charges of the particles 17 in the dispersion medium 19 and the surface charges of the capture layer 16 are set to negative potentials. Particularly desirably, the surface charges of the particles 17 and the surface charges of the capture layer 16 are set to negative potentials and absolute values of both of those potentials are high.

The ζ (zeta) potential of the particles 17 can be measured by a commercially available ζ (zeta) potential measuring apparatus. In the case where the particles were distributed into the water, an absolute value of the average ζ (zeta) potential of the particles 17 is desirably equal to 80 mV or more. If the dispersion medium 19 is a polar dispersion medium such as water, as a method of increasing a value of the ζ (zeta) potential of the particles 17, a method whereby the number of functional groups having the polarity on the surfaces of the particles 17 is increases or a method whereby the surfaces of the particles 17 are decorated by polar molecules can be mentioned.

Dispersion Medium

The dispersion medium 19 is not particularly limited but any medium can be used so long as it is a liquid at a room temperature. For example, the water, various kinds of organic solvents, or their mixture can be used. In order to more regularly capture and arrange the particles 17 onto the capture layer 16, it is desirable that a solvent having a large surface tension is used as a dispersion medium 19. A solvent which does not dissolve or swell the capture layer 16 is desirable as a dispersion medium 19. In the invention, the water is most desirable.

Dispersion Concentration of Particles

In order to regularly capture and arrange the particles 17 onto the capture layer 16, a dispersion concentration of the particles 17 in the dispersion liquid is also important. In the invention, a concentration of the particles 17 in the dispersion liquid is desirably equal to 30 to 40 weight %.

The particle dispersion liquid is prepared in consideration of the foregoing items.

Coating of Particle Dispersion Liquid

Subsequently, as illustrated in FIG. 3E, the dispersion liquid in which the particles 17 have been dispersed is coated onto the capture layer 16, thereby forming a coating film of the dispersion liquid. A coating method of the dispersion liquid is not particularly limited but the dispersion liquid can be coated onto the capture layer by an arbitrary method such as dipping method, spray coating method, scan coating method, or the like. If a liquid amount upon coating is set to be too large, an amount of dispersion medium 19 increases in association with it and a force at which the dispersion medium 19 pushes and flows the particles 17 increases. If such a force is too large, a layout of the particles 17 arranged onto the capture layer 16 deteriorates. In the invention, therefore, a method whereby the dispersion liquid can be coated in a wide range by a small amount of liquid such as a spray coating method is desirable. Specifically speaking, it is desirable that the liquid amount upon coating is set to a value within a range from 0.005 ml/cm² to 0.02 ml/cm². It is considered that a positional relation between the particles 17 and the capture layer 16 upon coating is as illustrated in FIG. 3E′ in view of a relation between the surface potential of the particles 17 and the surface potential of the capture layer 16. That is, since the capture layer 16 and the particles 17 have been subjected to the same charges (negative charges), they are in a state where an electrostatic repulsion has occurred between the capture layer 16 and the particles 17.

(6) Creation of Sediment Layer (FIG. 3F)

Subsequently, by drying the coating film and volatilizing the dispersion medium 19 from the coating film, a sediment layer 17a made of the particles 17 is formed. In this step, while the dispersion medium 19 is volatilized from the coating film, the particles 17 are put and arranged onto the capture layer 16. Although the electrostatic repulsion has occurred between the particles 17 and the capture layer 16 as mentioned above, the reason why the particles 17 are put and arranged onto the capture layer 16 in spite of the electrostatic repulsion is that a force stronger than an electrostatic repulsion force due to the electrostatic repulsion, that is, a capillary force which the dispersion medium 19 has acts. A drying method of the coating liquid in this step is not particularly limited. The substrate 11 may be naturally dried instead of the heat-drying. When the drying of the coating liquid progresses and the dispersion medium 19 is perfectly evaporated and removed, as illustrated in FIG. 3F, the sediment layer 17a made of the particles 17 is formed onto the capture layer 16 (in a region where the capture layer is not provided; onto the film 14 of the first translucent material or the translucent substrate 11 of the first translucent material).

(7) Capture of Particles onto Capture Layer (FIG. 3G)

Subsequently, the particles existing in the lowest layer of the sediment layer 17a are embedded into the capture layer 16 and captured. If the capture layer 16 is a layer containing the polymer, as a specific capturing method of the particles 17 existing in the lowest layer of the sediment layer 17a, a method of heating the capture layer 16 and softening the capture layer 16 can be mentioned. If the capture layer 16 is heated and softened, the particles in the lowest layer of the sediment layer 17a formed on the capture layer 16 sink into the capture layer 16 as illustrated in FIG. 3G and are perfectly captured into the capture layer 16. When the capture layer 16 is heated, it is desirable to heat it to a temperature which is equal to or higher than a glass transition point or a melting point of the polymer constructing the capture layer 16 and to a temperature which is lower than a glass transition point or a melting point of the material constructing the particles 17 which are embedded into the capture layer 16. On the other hand, there is a predetermined relation between a sinking depth of the particles 17 into the capture layer 16 and the heating temperature. It is desirable to set the heating temperature so that the particles 17 sink into the capture layer 16 to a depth which is equal to about the half of the diameter of the particle 17.

(8) Removing step of Particles which are not Captured into Capture Layer (FIG. 3H)

Subsequently, among the particles 17 contained in the sediment layer 17a illustrated in FIG. 3G, the particles 17 which are not captured in the capture layer 16 are removed. A specific removing method is not particularly limited. For example, an ultrasonic cleaning method or a cleaning by a high pressure shower can be mentioned. After the cleaning, as illustrated in FIG. 3H, among the particles 17, only the particles 17 which sank into the capture layer 16 and were captured into the capture layer 16 are left. Thus, a single-particle layer 17b made of the particles 17 which were captured into the capture layer 16 and arranged in the layer of one column is formed.

At the stage after completion of the above step, a filling rate adapted to decide a layout of the particles 17 captured in the capture layer 16 is defined by the following equation (2).

[Filling rate D(%)]=([the number of layouts of particles at each measuring position]/[the number of layouts of particles in the case where ideal hexagonal closest packing was performed])×100 (2)

An area which is measured when evaluating D is a square area in which one side is equal to a value which is 60 times as large as an area measured when the average particle size is obtained. When D is evaluated, it is desirable to measure the single-particle layer 17b at a plurality of positions and obtain its mean value and distribution σ. In the method of the invention, D is equal to 93% or more. That is, in the invention, a particle filling rate of the single-particle layer 17b is equal to 93% or more for the two-dimensional closest packing. A value obtained by subtracting σ from the mean value of D is, desirably, equal to 90% or more. The larger the value of D is, the smaller the value of σ is.

(9) Creation of Concave Portions into film or Substrate of First Translucent Material (FIG. 3I)

Subsequently, the film 14 of the first translucent material or the substrate 11 of the first translucent material is etched and a part thereof is removed, thereby forming concave portions. Thus, a concave/convex pattern of the first translucent material is formed. As a specific etching method, a general reactive ion etching method using a plasma or a general wet etching method using a solvent can be used. At this time, the particles 17 captured in the capture layer 16 function as a mask. That is, the capture layer 16 in a region other than the region where the particles 17 have been captured and the film 14 of the first translucent material or the substrate 11 of the first translucent material are etched in this step. Thus, the concave portions are formed in the film 14 of the first translucent material or the substrate 11 of the first translucent material. The region where the particles 17 have been captured remains in a convex shape. Consequently, the concave/convex pattern of the first translucent material is formed.

(10) Removal of Capture Layer (FIG. 3J)

Subsequently, the capture layer 16 remaining after the etching and the particles 17 captured in the capture layer 16 are removed from the film 14 of the first translucent material or the substrate 11 of the first translucent material. As a specific removing method, a general method using the solvent can be used. By removing the capture layer 16 and the particles 17 captured in the capture layer 16, as illustrated in FIG. 3J, the concave/convex pattern of the first translucent material appears on the substrate 11.

(11) Embedding by Second Translucent Material (FIG. 3K)

Subsequently, the concave portions formed in the film 14 of the first translucent material or the substrate 11 of the first translucent material mentioned above are embedded with the second translucent material. Thus, the film 15 of the second translucent material is formed. As a second translucent material, an inorganic material having a light transmittance and a predetermined refractive index in a manner similar to the first translucent material can be mentioned. However, the refractive index of the second translucent material itself differs from that of the first translucent material. As a second translucent material, a material whose refractive index is higher or lower than that of the first translucent material may be used. The film 15 of the second translucent material is formed, for example, as illustrated in FIG. 3K. As a component material of the film 15 of the second translucent material, an inorganic glass material such as SiO₂ or the like or an organic glass material in which a methyl group or the like has been introduced into the inorganic glass material can be mentioned. It is desirable that the refractive index of the film 15 of the second translucent material lies within a range from 1.2 to 1.8. As a filling method, a general dry deposition method such as sputtering method, CVD method, or the like, or a method whereby an oxide sol material is coated and dried is used. A method whereby an oxide sol such as SOG (Spin On Glass) or the like is coated and dried is desirable.

By the above steps, the light extracting structure 12 is formed onto the substrate 11.

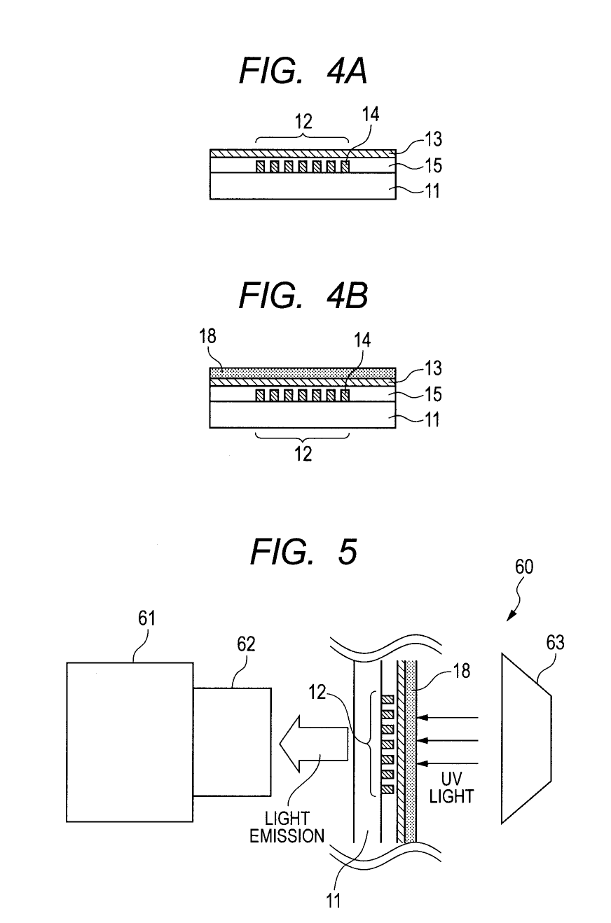

After the light extracting structure 12 was formed, the face plate 10 (refer to FIG. 1) is manufactured. FIGS. 4A and 4B are cross sectional diagrams illustrating manufacturing steps of the face plate.

After the light extracting structure 12 was formed, as illustrated in FIG. 4A, the anode electrode 13 is formed onto the film 15 of the second translucent material. As a component material of the anode electrode 13, a transparent conductive film such as ITO film, ZnO film, SnO film, or the like can be used. A refractive index of the anode electrode 13 is set to be desirably equal to or larger than that of the film 15 of the second translucent material. A forming method of the anode electrode 13 is not particularly limited.

Subsequently, as illustrated in FIG. 4B, the phosphor film 18 is formed as a phosphor layer onto the anode electrode 13. A forming method of the phosphor film 18 is not particularly limited. It is desirable that an average particle size of phosphor particles as a component material of the phosphor film 18 is equal to 1000 nm or less. Much desirably, the average particle size is equal to 300 nm or less. In the invention, “average particle size” is defined by a middle diameter (median diameter, that is, a center value D50 of the particle size distribution) and is a value which is statistically obtained from the particle size distribution (grain size distribution) based on the diameter corresponding to the sphere. The particle size distribution is measured by using a dynamic light scattering method. The refractive index of the phosphor film 18 can be measured by an ellipsometry. The refractive index of the phosphor film 18 is not a refractive index of the phosphor particles constructing the phosphor film 18 (refractive index that is peculiar to the phosphor material) but is an effective refractive index of the phosphor film 18 constructed by collecting a number of phosphor particles.

The light extracting structure contained in the face plate 10 (refer to FIG. 1) manufactured by the above steps can be evaluated by a light emission luminance of the light which is emitted when UV light is irradiated to the phosphor film 18. An evaluating method will be described in the following Examples together with an apparatus which is used at the time of evaluation.

The image display apparatus 1 described in FIG. 1 can be easily manufactured by using the face plate 10 manufactured as mentioned above. First, the face plate 10 manufactured by the foregoing process and the rear plate 41 are arranged through the supporting frame 42 of a closed loop shape therebetween so that the phosphor film 18 and the substrate 31 face each other. Subsequently, the face plate 10 and the rear plate 41 are adhered to the supporting frame 42. Then, the high-voltage terminal is electrically connected to the anode electrode 13 so as to penetrate the substrate 11. Finally, a space surrounded by the face plate 10, rear plate 41, and supporting frame 42 is evacuated to a vacuum state. In this manner, the image display apparatus 1 can be manufactured. A manufacturing method of the rear plate 41 is not particularly limited.

Example 1

The face plate is manufactured by the following method.

Step 1 (FIG. 3A)

First, the glass substrate 11 having a size of 30 mm×30 mm (high strain point low sodium glass “PD200” made by Asahi Glass Co., Ltd.) is sufficiently cleaned. Subsequently, a TiO₂ film is formed onto the substrate 11 by the sputtering method, thereby forming the film 14 of the first translucent material. At this time, a thickness of film 14 of the first translucent material is set to 1.2 μm.

Step 2 (FIG. 3B)

Second, a film of the photoresist (acrylic negative type photoresist (model No. “TR2001” made by JSR Co., Ltd.)) is coated and formed onto the film 14 of the first translucent material by the slit coating method, thereby forming the capture layer 16. At this time, a film thickness of capture layer 16 is equal to 8 μm. Subsequently, a base material on which the capture layer 16 has been formed is heated and dried at 60° C. for 12 minutes. A film thickness of capture layer 16 after the drying is equal to 1.5 μm.

Step 3 (FIG. 3C)

Subsequently, a patterning of the capture layer 16 is performed by the following method. Specifically speaking, a distance between the substrate 11 and the mask is maintained at 150 μm and light of an extra-high pressure mercury lamp of 250 W made by Ushio Inc. is irradiated in the atmosphere so that an irradiation energy density in the UV420 measurement is equal to 500 mJ/cm² by using a proximity exposing apparatus. Subsequently, an aqueous solution of 0.5% of tetramethylammonium hydroxide (hereinbelow, abbreviated to TMAM) is shower-sprayed at a room temperature and, thereafter, rinsed with the water. In this manner, the capture layer 16 is patterned and formed onto the film 14 of the first translucent material so that a film thickness is equal to 1.3 μm and a plurality of regions each having a size of 100 μm×250 μm exist.

Step 4 (FIG. 3D)

Subsequently, a surface treatment of the capture layer 16 is performed. Specifically speaking, after an excimer UV lamp was disposed at a position which is away from the high molecular layer 16 by 5 mm, light of a wavelength of 172 nm is irradiated at a rate of 1.5 J/cm² in the atmospheric ambience.

After the light was irradiated, a water contact angle of the surface of the capture layer 16 is measured and evaluated, so that the water contact angle is equal to 10° . The capture layer 16 after the irradiation is observed and analyzed by an infrared spectrum method. Thus, it has been confirmed that the number of —OH groups was increased as compared with that in the case where the light is not irradiated. Consequently, the surface of the capture layer 16 after the light irradiation has been charged to the negative charges for the water which is used as a dispersion medium in the embodiment.

Step 5 (FIG. 3E)

Subsequently, the particles 17 and the dispersion medium 19 are mixed and the dispersion liquid is adjusted.

In the embodiment, the silica particles are used as particles 17. In the embodiment, various kinds of commercially available silica particles are previously purchased, the silica particles are dispersed into the water at a rate of 0.1 weight %, respectively, and the ζ (zeta) potentials are measured. When the ζ (zeta) potentials are measured, “Zetasizer Nono ZS” made by Sysmex Corporation is used as a measuring apparatus. When measuring, a dip cell for a low dielectric constant solvent “ZEN1002” is used as a cell for measurement. As a result of the measurement of the ζ (zeta) potentials, “Hipresica SS (N7N)” made by Ube-Nitto Kasei Co., Ltd. exhibits high negative charges of −86 mV. Therefore, in the embodiment, “Hipresica SS (N7N)” made by Ube-Nitto Kasei Co., Ltd. is used as particles 17. Grain size distribution (%) of the silica particles has a range of 2% or less. About 100 silica particles are photographed by the electron microscope. The middle diameter is obtained by analyzing the photographed images. Thus, the middle diameter of the silica particles is equal to 1.7 μmφ.

The water is used as a dispersion medium 19 of the silica particles. The silica particles and the water are mixed and a dispersion liquid is adjusted. In this manner, the particle dispersion liquids in which concentrations of the particles to the dispersion medium 19 are equal to 10, 20, 30, 40, 50, and 60 weight % are prepared.

Subsequently, the particle dispersion liquid is coated onto the high molecular layer 16 by using the spray method. At this time, a distance between the spray nozzle and the substrate 11 is set to 10 cm, a spray pressure is set to 0.2 MPa, a discharge amount is set to 0.04 ml/sec, and a coating liquid amount is set to 0.01 ml/cm^{2.}

Step 6 (FIG. 3F)

Subsequently, the dispersion medium 19 is naturally dried at the room temperature and the sediment layer 17a made of the particles 17 is formed (FIG. 3F).

Step 7 (FIG. 3G)

Subsequently, the substrate 11 is heated and the capture layer 16 is softened. Specifically speaking, the substrate 11 is put into a baking furnace and heated. At this time, a temperature of the baking furnace is set to 230° C. When this step is executed, after the temperature of the baking furnace was set to 230° C., the substrate 11 is held at this temperature (230° C.) for 60 minutes. Then, the substrate 11 is cooled to the room temperature.

Step 8 (FIG. 3H)

Subsequently, the substrate 11 is taken out and the surface of the capture layer 16 is cleaned. Specifically speaking, the surface is cleaned by high pressure water by ejecting the micro liquid droplets from a micro jet nozzle. At this time, a pressure of the high pressure water is set to 17 MPa. After the cleaning, a cross section of the substrate is observed by the SEM. Thus, it could be confirmed that the single-particle layer 17b made of the particles 17 in which the silica particles had sunk into the capture layer 16 until a depth of 600 nm and had been captured therein was formed. By this cleaning, as illustrated in FIG. 3H, it has been confirmed that the particles which are not captured into the softened capture layer 16 were removed. A layout of the silica particles is observed by an optical microscope. 100 positions in the edges and center portion in the substrate are selected at random (so as not to cause a deviation in the evaluating positions) and the filling rates D of the silica particles are measured. Measurement results are shown in Table 1. The measurement results at 100 positions of a sample in each condition are evaluated with respect to the mean value and the distribution σ.

Step 9 (FIG. 3I)

Subsequently, the single-particle layer 17b made of the particles 17 which sank into the capture layer 16 is used as a mask, the film 14 of the first translucent material is etched, a part of the film 14 of the first translucent material is removed, and the concave/convex pattern is formed. As a specific etching method, the reactive ion etching method (hereinbelow, abbreviated to RIE) is used. More specifically speaking, first, an O₂ gas of 100 sccm is fed, a pressure in the apparatus is set to 2 Pa, a power of 200 W is introduced, and the RIE process is executed for 8 minutes.

Subsequently, a mixture gas of sulfur hexafluoride and argon (SF₆: 160 sccm, Ar: 40 sccm) is used, a pressure in the apparatus is set to 3 Pa, and the RIE process is executed for 11 minutes at a power of 1000 W. By this process, TiO₂ constructing the film 14 of the first translucent material is worked in a columnar shape. By this process, the substrate enters a state as illustrated in FIG. 3I.

Step 10 (FIG. 3J)

Subsequently, the capture layer 16 is removed by using the general peeling-off method using the solvent. As a solvent, an aqueous solution of 25% of tetramethylammonium hydroxide (TMAH) is used. Specifically speaking, the substrate 11 is dipped into the TMAH aqueous solution for 20 minutes and is ultrasonic-cleaned, thereby removing the capture layer 16.

After the capture layer 16 was removed, a cross section of the substrate is observed by the SEM. The pattern of the columnar (diameter of 1.2 μm; a height of 1.2 μm) film 14 of the first translucent material is formed in correspondence to the arrangement position of the particle 17. An average pitch of the columns of the film 14 of the first translucent material is equal to 1.7 μm that is the same as the diameter of the particle 17.

Step 11 (FIG. 3K)

Subsequently, a circumference of the columnar pattern of the film 14 of the first translucent material formed by the previous step is embedded with a material whose refractive index is smaller than that of the film 14 of the first translucent material, thereby forming the film 15 of the second translucent material. Specifically speaking, first, a dibutylether solution (coating type insulating film material, “Aquamica NN120-20” made by AZ Electronic Materials Co., Ltd.) of polysilazane is coated onto the substrate 11 by the spray method. Subsequently, the substrate 11 on which the polysilazane film has been formed is baked at 450° C. for 30 minutes by using an infrared furnace. A cross section of the substrate after the baking is observed by the SEM. As illustrated in FIG. 3K, it could be confirmed that a periodic structure was formed by the film 14 of the first translucent material made of TiO₂ and the film 15 of the second translucent material made of the polysilazane film.

Step 12 (FIG. 4A)

Subsequently, an ITO film is formed onto the film 15 of the second translucent material by the sputtering method, thereby forming the anode electrode 13.

Step 13 (FIG. 4B)

Subsequently, an IPA solution in which ethyl cellulose, phosphor particles, and isopropyl alcohol (IPA) have been mixed is adjusted. Then, the adjusted IPA solution is dripped as droplets onto the anode electrode 13 and spin-coated and, thereafter, dried, thereby forming an ethyl cellulose film (phosphor film 18) containing the phosphor particles. With respect to the formed phosphor film 18, a luminance of the phosphor at the time of the UV (wavelength: 254 nm) irradiation is evaluated. FIG. 5 is a schematic diagram illustrating a luminance evaluating apparatus of the phosphor film. A luminance evaluating apparatus 60 in FIG. 5 is constructed by: a UV light source 63; and an observing apparatus which is constructed by a luminance meter 61 and a microlens 62 and observes the phosphorescent light which is emitted from the phosphor film 18 when the UV light is irradiated. In the embodiment, as a UV light source 63, a handy UV lamp (model No. “SLUV-6” made by As One Corporation is used. As a luminance meter 61, a spectroradiometer (model No. “SR-UL1” made by Topcon Technohouse Corporation) is used. As a microlens 62, an attachment lens (model No. “AL-11” made by Topcon Technohouse Corporation) is used. The attachment lens is combined with the spectroradiometer, a focal point is focused to a region of about 70 μmφ, and the phosphorescent light is observed.

Every 50 positions in the region where the light extracting structure has been formed and the region where the light extracting structure is not formed are sampled and the luminance at each position is measured by using the luminance evaluating apparatus of FIG. 5. A luminance ratio between the forming region of the light extracting structure and the non-forming region is evaluated as a light extracting efficiency. A luminance deviation is observed through a visual inspection at a distance of 30 cm away from each sample. The sample in which the luminance deviation was observed is evaluated as “x” and the sample in which the luminance deviation is not observed is evaluated as “0”. Evaluation results are shown in Table 1.

TABLE 1

| | Coating | Filling rate (%) | | | Light | Lumi- |
|---|---|---|---|---|---|---|
| Dispersion | liquid | | | Mean | extracting | nance |
| concentration | amount | Mean | | value | efficiency | devia- |
| (weight %) | (ml/cm²) | value | σ | −σ | (times) | tion |
| 10 | 0.01 | 90 | 5 | 85 | 1.41 | x |
| 20 | 0.01 | 93 | 3 | 90 | 1.42 | ◯ |
| 30 | 0.01 | 95 | 2 | 93 | 1.42 | ⊚ |
| 40 | 0.01 | 95 | 2 | 93 | 1.42 | ⊚ |
| 50 | 0.01 | 93 | 3 | 90 | 1.42 | ◯ |
| 60 | 0.01 | 85 | 10 | 75 | 1.39 | x |

(⊚: The luminance deviation is not observed and the luminance of phosphorescent light is large.)

From the results of Table 1, it has been confirmed that when the mean value of the filling rate of the particles 17 which are filled onto the capture layer 16 is equal to 93% or more, there is no luminance deviation and the large light extracting efficiency can be accomplished. That is, by setting the filling rate of the particles 17 which are filled onto the capture layer 16 to 93% or more for the two-dimensional closest packing, the manufacturing method of the image display apparatus in which the luminance has been improved can be provided.

### Comparative Example 1

In Example 1, when step 4 is executed, the surface treatment of the capture layer 16 is executed so that a water contact angle of the surface of the capture layer 16 is equal to 70°. Specifically speaking, an intensity of the UV light which is irradiated to the capture layer 16 is set to 1.5 J/cm². When step 5 is executed, the particles whose ζ (zeta) potential is equal to −70 mV (“SHINSHIKYU™ Series SW” made by JGC Catalysts and Chemicals Ltd.) are used as particles 17. The face plate is manufactured by a method similar to that in Example 1 except for the above conditions.

In this Comparative Example, after step 4, when the capture layer 16 is analyzed by the infrared spectrum method, an increase in number of —OH groups is observed as compared with that before the UV light is irradiated. However, an increase amount of the —OH groups is smaller than that in Example 1. Therefore, in this Comparative Example, although the surface of the capture layer 16 after the UV light was irradiated has a negative polarity for the water serving as a dispersion medium 19, an absolute value of the charge is smaller than that of Example 1.

With respect to the substrate 11 after step 8 was executed, the filling rate of the particles is evaluated in a manner similar to Example 1. Further, with respect to the substrate 11 after step 13 was executed, the light extracting efficiency and the luminance deviation are evaluated in a manner similar to Example 1. Evaluation results are shown in Table 2. In this Comparative Example, a shape of the film of the first translucent material formed on the substrate is a columnar shape having a diameter and a height similar to those in Example 1 and has an average pitch similar to that in Example 1.

TABLE 2

| | Coating | Filling rate (%) | | | Light | Lumi- |
|---|---|---|---|---|---|---|
| Dispersion | liquid | | | Mean | extracting | nance |
| concentration | amount | Mean | | value | efficiency | devia- |
| (weight %) | (ml/cm²) | value | σ | −σ | (times) | tion |
| 10 | 0.01 | 70 | 10 | 60 | 1.35 | x |
| 20 | 0.01 | 80 | 10 | 70 | 1.38 | x |
| 30 | 0.01 | 80 | 10 | 70 | 1.38 | x |
| 40 | 0.01 | 85 | 10 | 75 | 1.39 | x |
| 50 | 0.01 | 85 | 10 | 75 | 1.39 | x |
| 60 | 0.01 | 85 | 10 | 75 | 1.39 | x |

From the results of Table 2, in this Comparative Example, the mean value of the filling rate of the particles is equal to 85% or less in all of the conditions. When comparing with the results of Example 1, in the case of the face plate manufactured in this Comparative Example, the light extracting efficiency and the luminance deviation are inferior to those in Example 1.

From the results of Example 1 and Comparative Example 1, in order to accomplish the face plate in which there is no luminance deviation and the light extracting efficiency is large, it is necessary to set the mean value of the filling rate of the particles to 93% or more. In order to set the mean value of the filling rate of the particles to 93% or more, it is necessary to control the surface charges of the high molecular layer 16. The present inventors et al. consider that, as factors of it, if the surface charges of the high molecular layer 16 are small, when the particle dispersion liquid is coated and dried, the particles 17 are liable to be adsorbed to the substrate, and this becomes a factor of obstructing the particle layout.

### Comparative Example 2

In Comparative Example 2, when step 5 is executed, particles whose surfaces have been decorated by a surface decorating material are used. Specifically speaking, as a surface decorating material of the particles 17, a polydiallyl dimethylammonium chloride is added to the dispersion medium by 0.001 weight % and sufficiently stirred. The face plate is manufactured by a method similar to that in Comparative Example 1 except for the above conditions. The ζ (zeta) potential at the time when the particles were dispersed to the water (dispersion medium) by 0.1 weight % by the surface decoration is equal to +35 mV. Other conditions are set to be identical to those in Comparative Example 1.

With respect to the substrate 11 after step 8 was executed, the filling rate of the particles is evaluated in a manner similar to Example 1. Further, with respect to the substrate 11 after step 13 was executed, the light extracting efficiency and the luminance deviation are evaluated in a manner similar to Example 1. Evaluation results are shown in Table 3. In this Comparative Example, a shape of the film of the first translucent material formed on the substrate is a columnar shape having a diameter and a height similar to those in Example 1 and has an average pitch similar to that in Example 1.

TABLE 3

| | Coating | Filling rate (%) | | | Light | Lumi- |
|---|---|---|---|---|---|---|
| Dispersion | liquid | | | Mean | extracting | nance |
| concentration | amount | Mean | | value | efficiency | devia- |
| (weight %) | (ml/cm²) | value | σ | −σ | (times) | tion |
| 10 | 0.01 | 65 | 2 | 63 | 1.34 | x |
| 20 | 0.01 | 65 | 2 | 63 | 1.34 | x |
| 30 | 0.01 | 65 | 2 | 63 | 1.34 | x |
| 40 | 0.01 | 65 | 2 | 63 | 1.34 | x |
| 50 | 0.01 | 65 | 2 | 63 | 1.34 | x |
| 60 | 0.01 | 65 | 2 | 63 | 1.34 | x |

From the results of Table 3, in this Comparative Example, the mean value of the filling rate of the particles is equal to 65% or less in all of the conditions. When comparing with the results of Example 1, in the case of the face plate manufactured in this Comparative Example, the light extracting efficiency and the luminance deviation are inferior to those in Example 1.

From the results of Example 1 and Comparative Example 2, in order to accomplish the face plate in which there is no luminance deviation and the light extracting efficiency is large, it is necessary to set the mean value of the filling rate of the particles to 93% or more. In order to set the mean value of the filling rate of the particles to 93% or more, it is necessary to control the surface charges of the high molecular layer 16 to a negative polarity. The present inventors et al. consider that, as factors of it, if the surface charges of the high molecular layer 16 and the surface charges of the particles 17 have opposite polarities, when the particle dispersion liquid is coated and dried, the particles 17 are more liable to be adsorbed to the substrate, and this becomes a factor of obstructing the particle layout.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-205720,filed Sep. 14, 2010,which is hereby incorporated by reference herein in its entirety.

1. A forming method of a light extracting structure, comprising:
(a) forming a capture layer onto at least either a substrate or a film made of a first translucent material;
(b) applying a dispersion liquid in which particles have been dispersed into a dispersion medium onto the capture layer, volatilizing the dispersion medium, and forming a sediment layer of the particles onto the capture layer;
(c) embedding the particles in a lowest layer of the sediment layer into the capture layer and capturing;
(d) removing the particles which are not captured in the capture layer;
(e) using the particles captured in the capture layer as a mask, removing a part of the capture layer and the substrate or the film of the first translucent material, and forming a plurality of concave portions into the substrate or the film of the first translucent material;
(f) removing the particles and the capture layer after the step (e); and
(g) embedding the plurality of concave portions formed in the substrate or the film of the first translucent material by a second translucent material whose refractive index differs from that of the first translucent material,
wherein, a particle filling rate of the particles captured in the capture layer in the step (c) is equal to 93% or more for a two-dimensional closest packing.

2. The method according to claim 1, wherein the capture layer which is formed in the step (a) is a layer containing a polymer, a glass transition point or a melting point of a material constructing the particles in the dispersion liquid which is applied in the step (b) is set to be higher than a glass transition point or a melting point of the polymer contained in the capture layer, and the step (c) is executed by heating the capture layer to a temperature which is equal to or higher than the glass transition point or the melting point of the polymer and which is lower than the glass transition point or the melting point of the material constructing the particles.

3. The method according to claim 1, wherein between the steps (a) and (b), by controlling surface charges of the particles and the capture layer, a particle filling rate of the particles captured in the capture layer is set to 93% or more for a two-dimensional closest packing.

4. The method according to claim 3, wherein the surface charges of the particles and the surface charges of the capture layer are controlled to a negative polarity.

5. The method according to claim 1, wherein a concentration of the particles in the dispersion liquid which is applied in the step (b) lies within a range from 30 to 40 weight %.

6. A manufacturing method of a light-emitting substrate having a light extracting structure for extracting light emitted from a light-emitting layer, wherein
the light extracting structure is formed by the forming method of the light extracting structure according to claim 1.

7. A manufacturing method of an image display apparatus having a light extracting structure for extracting light emitted from a light-emitting layer, wherein
the light extracting structure is formed by the forming method of the light extracting structure according to claim 1.

8. The method according to claim 7, wherein the image display apparatus is a field emission display.

9. The method according to claim 7, wherein the image display apparatus is an electroluminescence display.
